(19) United States
(12) Patent Application Publication
(10) Pub. No.: US 2025/0307681 A1
(43) Pub. Date: Oct. 2, 2025

(54) USING A QUANTUM SENSOR TO APPROXIMATE A QUANTUM STATE

(71) Applicant: Classiq Technologies LTD., Tel Aviv (IL)

(72) Inventors: Eyal Cornfeld, Ramat Gan (IL); Ofek Kirzner, Haifa (IL); Shmuel Ur, Shorashim (IL); Amir Naveh, Haifa (IL); Nir Minerbi, Haifa (IL)

(21) Appl. No.: 18/620,455

(22) Filed: Mar. 28, 2024

(51) Int. Cl. G06N 10/60; G06N 10/20; G06N 10/40

(52) U.S. Cl. CPC G06N 10/60; G06N 10/20; G06N 10/40

(57) ABSTRACT

A system, apparatus and product comprising: a quantum sensor that is configured to measure a property of a first physical phenomenon; a quantum computer that is configured to execute a parametric quantum circuit comprising qubits that are set to represent the property of the first physical phenomenon, wherein the parametric quantum circuit comprises: an ansatz parametric circuit configured to approximate a target quantum state of a second physical phenomenon, and to output a manipulated quantum state; and an assessing module configured to assess an expectation value of operators on the manipulated quantum state; wherein said quantum computer is configured to implement a Variational Quantum Eigensolver (VQE) scheme to iteratively adjust values of a set of parameters defining the ansatz parametric circuit until the assessing module provides a desired expectation value; and an output module configured to output the desired expectation value.

### TECHNICAL FIELD

The present disclosure relates to quantum computing in general, and to approximating a quantum state based on measurements of a quantum sensor, in particular.

### BACKGROUND

Quantum computing is a computational paradigm that is fundamentally different from classical computing. In contrast to classical computing, which utilizes bits, quantum computing utilizes quantum bits (qubits). The qubits have unique features, as each qubit can be in superposition, several qubits can be entangled, and all operations on qubits besides measurement (referred to as quantum gates) must be reversible.

Classical sensors, relying on classical physics principles, have long been the cornerstone of sensing technologies. Classical sensors may be used to measure classical data such as the position and distance of objects, temperatures, changes in pressures, the intensity of light, or the like. Quantum sensors, on the other hand, represent a paradigm shift in sensing capabilities, harnessing the principles of quantum mechanics to unlock unprecedented levels of sensitivity and precision.

Unlike classical sensors, which rely on classical physics to detect and quantify physical quantities, quantum sensors leverage the unique properties of quantum states, such as superposition and entanglement, to enable highly precise and sensitive measurements at the quantum scale that surpass the capabilities of classical sensors. This can be done with photonic systems, solid state systems, or the like. By exploiting quantum properties such as entanglement, quantum interference, and quantum state squeezing, quantum sensors can provide unprecedented levels of accuracy in measuring various physical parameters such as electromagnetic fields, quantum phenomena, and gravitational forces.

### BRIEF SUMMARY

One exemplary embodiment of the disclosed subject matter is a system comprising: a quantum sensor that is configured to measure at least one property of a first physical phenomenon; a quantum computer that is connectable to said quantum sensor, said quantum computer is configured to execute a parametric quantum circuit, wherein the parametric quantum circuit comprises one or more qubits that are set, by said quantum sensor, with a sensed quantum state, the sensed quantum state representing the at least one property of the first physical phenomenon, wherein the parametric quantum circuit comprises: an ansatz parametric circuit implementing an ansatz, wherein the ansatz parametric circuit is configured to approximate a target quantum state of a second physical phenomenon, the ansatz parametric circuit is configured to manipulate the sensed quantum state of the one or more qubits, thereby outputting at least one manipulated quantum state; and an assessing module configured to obtain the at least one manipulated quantum state from the ansatz parametric circuit, and to assess an expectation value of one or more operators on the at least one manipulated quantum state; wherein said quantum computer is configured to implement a Variational Quantum Eigensolver (VQE) scheme to iteratively adjust one or more values of a set of parameters defining the ansatz parametric circuit until the assessing module provides a desired expectation value; and an output module configured to output the desired expectation value.

Optionally, the first physical phenomenon is different from the second physical phenomenon.

Optionally, the first physical phenomenon and the second physical phenomenon belong to a same category of physical objects.

Optionally, the first physical phenomenon and the second physical phenomenon are identical phenomena.

Optionally, said system is configured to reset a state of the first physical phenomenon between iterations of the VQE scheme.

Optionally, said system is configured to load the one or more qubits with sensed quantum states measured by said quantum sensor every iteration of the VQE scheme.

Optionally, said quantum computer is configured to execute the parametric quantum circuit with different valuations of the set of parameters every iteration of the VQE scheme, thereby executing different ansatz parametric circuits every iteration of the VQE scheme.

Optionally, said execute comprises executing the parametric quantum circuit a plurality of times for a single iteration of the VQE scheme.

Optionally, said system is configured to measure one or more outputs from executions of the parametric quantum circuit and adjust valuations of the set of parameters based on the one or more outputs.

Optionally, said quantum sensor and quantum computer are housed in a single physical device, whereby the quantum computer is an on-sensor embedded quantum computer.

Optionally, said output module is configured to provide the desired expectation value to at least one of a quantum computer and a classical computer.

Optionally, the at least one property comprises a quantum property of the first physical phenomenon.

Optionally, the desired expectation value comprises a minimal expectation value.

Another exemplary embodiment of the disclosed subject matter is an apparatus comprising a processor and coupled memory, said processor being adapted to: measure at least one property of a first physical phenomenon, said measure is performed by a quantum sensor; execute a parametric quantum circuit at a quantum computer that is connectable to said quantum sensor, wherein the parametric quantum circuit comprises one or more qubits that are set, by said quantum sensor, with a sensed quantum state, the sensed quantum state representing the at least one property of the first physical phenomenon, wherein the parametric quantum circuit comprises: an ansatz parametric circuit implementing an ansatz, wherein the ansatz parametric circuit is configured to approximate a target quantum state of a second physical phenomenon, the ansatz parametric circuit is configured to manipulate the sensed quantum state of the one or more qubits, thereby outputting at least one manipulated quantum state; and an assessing module configured to obtain the at least one manipulated quantum state from the ansatz parametric circuit, and to assess an expectation value of one or more operators on the at least one manipulated quantum state; implement, at said quantum computer, a Variational Quantum Eigensolver (VQE) scheme to iteratively adjust one or more values of a set of parameters defining the ansatz parametric circuit until the assessing module provides a desired expectation value; and output the desired expectation value.

Yet another exemplary embodiment of the disclosed subject matter is a computer program product comprising a non-transitory computer readable medium retaining program instructions, which program instructions when read by a processor, cause the processor to: measure at least one property of a first physical phenomenon, said measure is performed by a quantum sensor; execute a parametric quantum circuit at a quantum computer that is connectable to said quantum sensor, wherein the parametric quantum circuit comprises one or more qubits that are set, by said quantum sensor, with a sensed quantum state, the sensed quantum state representing the at least one property of the first physical phenomenon, wherein the parametric quantum circuit comprises: an ansatz parametric circuit implementing an ansatz, wherein the ansatz parametric circuit is configured to approximate a target quantum state of a second physical phenomenon, the ansatz parametric circuit is configured to manipulate the sensed quantum state of the one or more qubits, thereby outputting at least one manipulated quantum state; and an assessing module configured to obtain the at least one manipulated quantum state from the ansatz parametric circuit, and to assess an expectation value of one or more operators on the at least one manipulated quantum state; implement, at said quantum computer, a Variational Quantum Eigensolver (VQE) scheme to iteratively adjust one or more values of a set of parameters defining the ansatz parametric circuit until the assessing module provides a desired expectation value; and output the desired expectation value.

Yet another exemplary embodiment of the disclosed subject matter is a method comprising: measuring at least one property of a first physical phenomenon, said measuring is performed by a quantum sensor; executing a parametric quantum circuit at a quantum computer that is connectable to said quantum sensor, wherein the parametric quantum circuit comprises one or more qubits that are set, by said quantum sensor, with a sensed quantum state, the sensed quantum state representing the at least one property of the first physical phenomenon, wherein the parametric quantum circuit comprises: an ansatz parametric circuit implementing an ansatz, wherein the ansatz parametric circuit is configured to approximate a target quantum state of a second physical phenomenon, the ansatz parametric circuit is configured to manipulate the sensed quantum state of the one or more qubits, thereby outputting at least one manipulated quantum state; and an assessing module configured to obtain the at least one manipulated quantum state from the ansatz parametric circuit, and to assess an expectation value of one or more operators on the at least one manipulated quantum state; implementing, at said quantum computer, a Variational Quantum Eigensolver (VQE) scheme to iteratively adjust one or more values of a set of parameters defining the ansatz parametric circuit until the assessing module provides a desired expectation value; and outputting the desired expectation value.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A-1B show schematic block diagrams, in accordance with some exemplary embodiments of the disclosed subject matter;

FIG. 2 shows an exemplary flowchart diagram of a method, in accordance with some exemplary embodiments of the disclosed subject matter; and

FIG. 3 shows an exemplary block diagram of an apparatus, in accordance with some exemplary embodiments of the disclosed subject matter.

### DETAILED DESCRIPTION

One technical problem dealt with by the disclosed subject matter is measuring a full quantum state of a physical phenomenon, physical system, physical object, or the like (referred to herein as “physical phenomenon”). For example, a full quantum state of a physical phenomenon, also referred to as the target quantum state, may represent the energy of a certain molecule at a certain position, time, or the like.

In some exemplary embodiments, the quantum state, such as the energy of the molecule, may not be directly measurable. For example, this may be the case for complex quantum states. In some cases, a quantum sensor may not be enabled to measure the full quantum state of the physical phenomenon, but may rather be enabled to measure a limited number of properties of the quantum state. For example, a quantum sensor may be enabled to measure a subset of the parameters defining the full quantum state, properties, or attributes of the physical phenomenon that are not represented by parameters defining the full quantum state, a combination thereof, or the like. It may be desired to overcome these challenges and provide a measurement or approximation of the full quantum state of the physical phenomenon.

In some cases, a naïve solution includes using variational quantum computing techniques for approximating the full quantum state of the physical phenomenon. In some exemplary embodiments, variational algorithms such as Variational Quantum Algorithms (VQAs) may be designed to address problems for which the solution is not known in advance, such as in the realm of eigenvalue problems.

In some exemplary embodiments, a VQA may constitute a quantum algorithm class that may be used for solving optimization problems. In some exemplary embodiments, VQAs may involve an iterative process where a parameterized quantum circuit is constructed, executed, and measured; the measurement results may be used to determine the construction of the next iterated circuit. For example, in each iteration, the parameters of the parameterized quantum circuit may be adjusted, causing the construction of a different parameterized quantum circuit.

In some exemplary embodiments, the VQA iterations may be executed for different logical variations of logical parameters associated with the parametric quantum circuit. For example, one or more VQA algorithms are disclosed in M. Cerezo, et al. Variational Quantum Algorithms. arXiv: 2012.09265. Nature Reviews Physics 3, 625-644 (2021), which is hereby incorporated by reference in its entirety for all purposes without giving rise to disavowment (hereinafter referred to as ‘M. Cerezo’).

In some exemplary embodiments, the VQA framework may constitute a broad category that encompasses one or more algorithms, instances, or the like, such as a Variational Quantum Eigensolver (VQE). In some exemplary embodiments, VQE may comprise a specific variational algorithm tailored for solving quantum eigenvalue problems. For example, VQE may focus on finding the ground state energy of a given Hamiltonian, making it particularly well-suited for quantum chemistry simulations. In some exemplary embodiments, VQE algorithms may be implemented according to one or more methods disclosed in Peruzzo, A., McClean, J., Shadbolt, P. et al. A variational eigenvalue solver on a photonic quantum processor. Nat Commun 5, 4213 (2014), which is hereby incorporated by reference in its entirety for all purposes without giving rise to disavowment, and/or according to one or more methods disclosed in M. Cerezo.

In some exemplary embodiments, within the VQE algorithm, an ansatz parametric quantum circuit (referred to as ‘ansatz parametric circuit’) may be generated, prepared, designed, or the like, along with a parameter assignment for an eigenvector. In some exemplary embodiments, an ansatz parametric circuit may represent, or implement, an ansatz (e.g., a hypothesis, or educated guess) associated with the unknown quantum state of the physical phenomenon. For example, in case the physical phenomenon is energy of a molecule, the ansatz may represent a hypothesis that attempts to approximate the energy of the molecule. For example, the hypothesis may comprise a guessed quantum state, or eigenvector, that may or may not provide an approximation of the energy of the molecule.

In some exemplary embodiments, an ansatz parametric circuit implementing the ansatz may comprise a quantum circuit (or subcircuit) that, when executed on a quantum execution platform, is configured to output the guessed quantum state, in accordance with the ansatz. In some exemplary embodiments, the ansatz parametric circuit may be designed as a hardware-oriented ansatz, a physics-oriented ansatz, or as any other type of ansatz. In some exemplary embodiments, a hardware-oriented ansatz may be formulated as a random and maximally condensed quantum circuit that can be efficiently executed on a quantum computer, e.g., in terms of cycle-wise depth, error rates, costs, gate count, or the like. In some exemplary embodiments, any other types of ansätze and associated parameters may be used, e.g., similar to the ansätze and parameters disclosed in M. Cerezo.

In some exemplary embodiments, according to the naïve solution, the ansatz parametric circuit may be initialized, set, or the like, with one or more arbitrary states, random states, ground states (e.g., the |0 [symbol] state), or the like. For example, in case the ansatz parametric circuit is designed as a hardware-oriented ansatz, the hardware-oriented ansatz may be initialized with zero or ground states. In some exemplary embodiments, after preparing the ansatz parametric circuit and setting the initial parameter values of its qubits, the ansatz parametric circuit may be configured to manipulate the initial quantum states of the qubits, such as according to one or more parameters of the ansatz parametric circuit, which may define one or more gates or quantum operations. In some exemplary embodiments, an output from the ansatz parametric circuit may be configured to be assessed by an assessing module.

In some exemplary embodiments, during execution of a quantum circuit that comprises the ansatz parametric circuit and an assessing module, one or more manipulated quantum states of the qubits may be outputted from the ansatz parametric circuit, and fed to the assessing module. In some exemplary embodiments, the assessing module may be configured to evaluate, or assess, one or more expectation values of a desired operator on the ansatz. For example, in case the physical phenomenon represents the energy of a molecule, the assessing module may assess, for the manipulated quantum state from the ansatz parametric circuit, a corresponding expectation value of an energy operator. According to this example, the assessing module may output predicted energy of the manipulated quantum state, of a molecule represents by the manipulated quantum state, or the like.

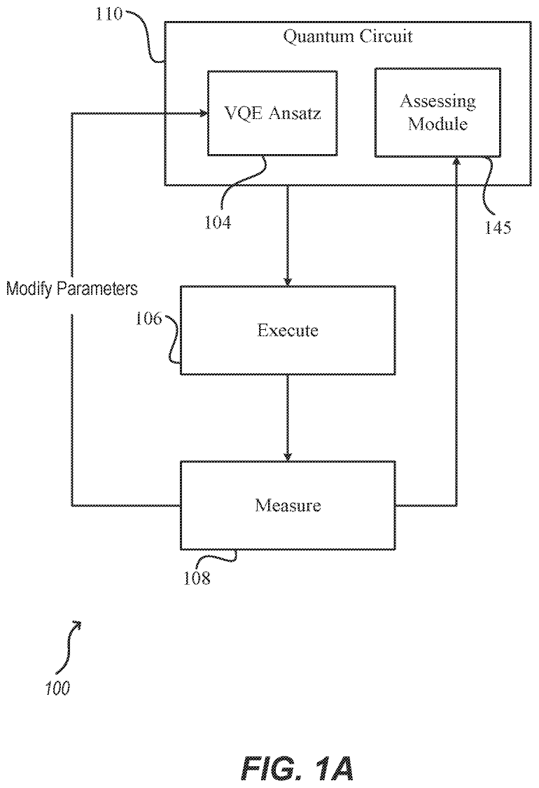

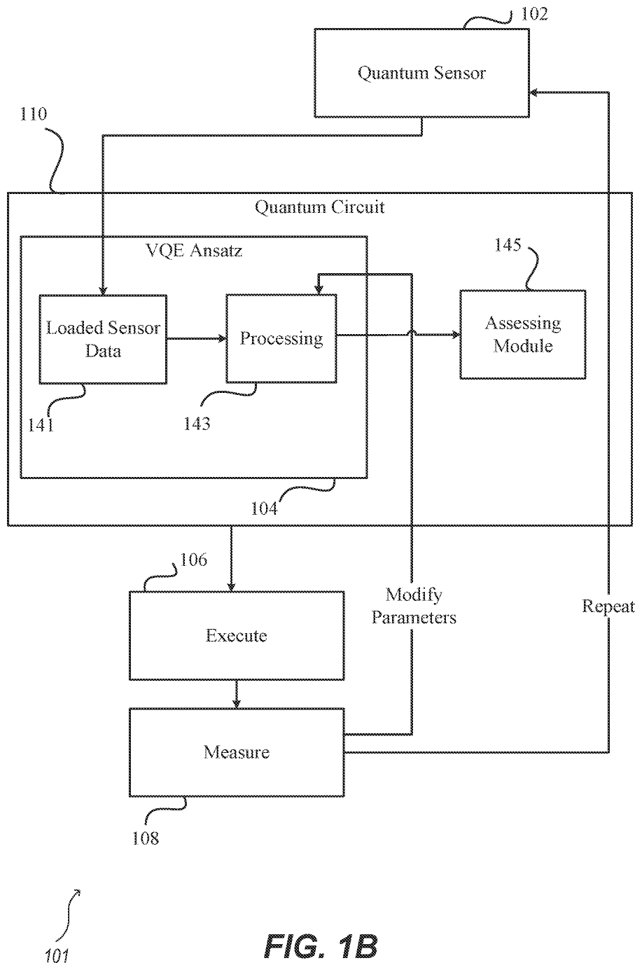

In some exemplary embodiments, the quantum circuit that includes the ansatz parametric circuit and the assessing module, may be executed on a quantum execution platform, and one or more measurements may be performed to assess the results. In some exemplary embodiments, measurements may enable to determine the expectation value provided by the assessing module. In some exemplary embodiments, based on the measurements, the VQE algorithm may determine the variation of the ansatz parameters for the next iteration of execution. In some cases, based on the measurements, the VQE algorithm may determine one or more adjustments of the assessing module for the next iteration of execution. For example, a classical processing unit may obtain measurement results, and determine based thereon one or more adjustments to the ansatz parametric circuit, the assessing module, or to any other portion of the quantum circuit. In some exemplary embodiments, by adjusting parameters and/or subcircuits based on the observed expectation values (which correspond to the eigenvalues of specific operators), the VQE algorithm may iteratively adjust parameter values of the ansatz parametric circuit, until selecting optimal parameters that minimize the expectation value (and the corresponding eigenvalue), that provide a desired expectation value, or the like. For example, for an energy operator, the VQE algorithm may terminate upon measuring a minimal expectation value that correspond to the ground state energy of the molecular system. In some cases, the naïve method may implement the VQE algorithm according to the block diagram of FIG. 1A.

Referring now to FIG. 1A, depicting an exemplary schematic block diagram, in accordance with some exemplary embodiments of the disclosed subject matter.

In some exemplary embodiments, Block Diagram 100 may depict a VQE framework that is configured to approximate a full quantum state of a physical phenomenon, that cannot be measured directly. In some exemplary embodiments, Block Diagram 100 may depict blocks, each of which represents a component, stage, or subsystem of the disclosed subject matter, and interconnections between the blocks may illustrate how these components interact or are related in terms of functionality or information flow.

As depicted in FIG. 1A, a flow of Block Diagram 100 starts with VQE Ansatz 104, within Quantum Circuit 110, which constitutes the ansatz parametric circuit such as a hardware-oriented ansatz. In some exemplary embodiments, VQE Ansatz 104 may represent an ansatz attempting to approximate a full quantum state of a physical phenomenon, and may be implemented differently for different VQE iterations, according to adjustable parameters.

In some exemplary embodiments, one or more quantum states that exit VQE Ansatz 104 may be fed to Assessing Module 145, which may also be comprised within Quantum Circuit 110. For example, Assessing Module 145 may be configured to be executed subsequently to VQE Ansatz 104, to portions thereof, or the like. In some exemplary embodiments, Assessing Module 145 may be configured to assess the expectation value of an operator (e.g., the energy operator) on VQE Ansatz 104. For example, Assessing Module 145 may determine energy (e.g., the eigenvalue) of a molecule that corresponds to a quantum state from VQE Ansatz 104.

In some exemplary embodiments, Quantum Circuit 110 may be executed, during an Execute 106 stage, and its results may be measured during a Measure 108 stage. For example, Execute 106 may comprise executing Quantum Circuit 110 once, a plurality of times, or the like. In some cases, Measure 108 may measure an output state of each execution using tomography measurements, or using any other technique.

In some exemplary embodiments, based on the measurements, the expectation value provided by Assessing Module 145 may be estimated, determined, or the like, e.g., at a classical processing unit such as Measure 108. In some exemplary embodiments, based on the expectation value, a determination as to whether the VQE iterations should terminate or continue may be made, e.g., by the classical processing unit. For example, in case the expectation value is determined to be a minimal eigenvalue, the VQE iterations may be terminated. Otherwise, the parameter values of VQE Ansatz 104 may be adjusted for a subsequent VQE iteration, one or more properties of Assessing Module 145 may be adjusted, or the like. In some exemplary embodiments, the parameters of VQE Ansatz 104 may be adjusted based on the observed expectation values from Assessing Module 145, until a selection of parameters of VQE Ansatz 104 minimizes the expectation values of the operator on VQE Ansatz 104, resulting with an approximation of the ground state energy of the molecular system. For example, the parameters may be determined to minimize the expectation values in case of a local minimum, a global minimum, or the like, and such parameters may be referred to as optimal parameters. In other cases, the VQE iterations may terminate when the selection of parameters of VQE Ansatz 104 provides a desired expectation value that does not minimize the expectation values of the operator on VQE Ansatz 104.

It is noted that a single VQE iteration may comprise a single execution of Quantum Circuit 110, a plurality of executions of Quantum Circuit 110, a single measurement of each execution, a plurality of measurements of each execution, or the like. In some exemplary embodiments, every iteration, the parameters of VQE Ansatz 104 may be adjusted, such as by Measure 108 or by another classical processing unit. In some cases, Assessing Module 145 may be modified, adjusted, or the like, between one or more VQE iterations, between one or more executions of Quantum Circuit 110, or the like. For example, Assessing Module 145 may be adjusted or modified a plurality of times, such as according to predefined configurations of Assessing Module 145. In some cases, each selection of parameters of VQE Ansatz 104 may be performed after a respective plurality of adjustments are made to Assessing Module 145.

The naïve solution, such as the solution of Block Diagram 100, may have one or more drawbacks. For example, in many cases, the naïve solution may require a large number of iterations (e.g., hundreds, thousands, millions, billions, or the like), until finding optimal parameters for minimizing the expectation value. These iterations may incur a large cost in terms of resources, as this may require large amounts storage resource, computation resources, or the like.

Another technical problem dealt with by the disclosed subject matter is overcoming the drawbacks of the naïve solution, such as reducing the number of iterations that is needed for minimizing the expectation value.

One technical solution provided by the disclosed subject matter is optimizing the initialization stage of the ansatz parametric circuit. In some exemplary embodiments, instead of initializing the ansatz parametric circuit with random states, arbitrary states, or with zero states (e.g., ground states), as performed in the naïve method, the ansatz parametric circuit may be initialized with one or more states associated with a quantum sensor.

In some exemplary embodiments, the ansatz parametric circuit may be initialized, set, or the like, with a sensed quantum state measured by a quantum sensor and loaded to the ansatz parametric circuit. In some exemplary embodiments, initializing the ansatz parametric circuit with the sensed quantum state may reduce the number of iterations required by the VQE technique. For example, the sensed quantum state may have a smaller distance, or to be more similar, to the full quantum state of the physical phenomenon, compared to zero or random quantum states. In is noted that the term “initializing”, when used herein with respect to a circuit, may refer to setting a state of one or more qubits at one or more initial and/or intermediate cycles of the circuit.

In some exemplary embodiments, quantum sensors may be configured to sense, measure, or the like, quantum properties of a physical phenomenon, physical system, physical object, or the like. In some exemplary embodiments, quantum sensors may be sensitive to quantum properties such as a magnetic field of an atom, a location of an atom, a speed of an atom, a magnetic field of a molecule, a location of a molecule, a speed of a molecule, a quantum state of a physical situation, quantum information processing, quantum information measuring, or the like.

In some exemplary embodiments, a quantum sensor may store a measurement of one or more quantum properties as a quantum state. In some exemplary embodiments, the information stored in quantum sensors, e.g., the quantum state, may be loadable on qubits of a quantum computer, e.g., as disclosed in Vorobyov, V., Zaiser, S., Abt, N. et al. Quantum Fourier transform for nanoscale quantum sensing. npj Quantum Inf 7, 124 (2021).doi.org/10.1038/s41534-021-00463-6, which is hereby incorporated by reference in its entirety for all purposes without giving rise to disavowment. For example, the sensed quantum state may be loaded to one or more qubits of a quantum computer.

In some exemplary embodiments, a quantum sensor may be configured to load a sensed quantum state of a given physical system onto one or more qubits of a quantum computer that is connectable to the quantum sensor. For example, the quantum computer may be physically wired or connected to the quantum sensor, or may connect to the quantum sensor in a wireless manner, such as by entanglement.

In some exemplary embodiments, the quantum sensor may be configured to measure the same physical phenomenon for which a target quantum state is desired, a different physical phenomenon, object, or the like. For example, the target quantum state may comprise energy of a molecule, and the quantum sensor may measure one or more properties of the same molecule. In some cases, the quantum sensor may measure a physical system that is similar to the target physical phenomenon (e.g., having overlapping parameters). For example, the target quantum state may comprise energy of a molecule, while the quantum sensor may measure energy of an atom. In some cases, the quantum sensor may measure a physical phenomenon that is of a same type of the target physical phenomenon. For example, the target quantum state may comprise energy of a molecule, while the quantum sensor may measure energy of a different molecule, energy of the same molecule at a different time or state, or the like. In some cases, the quantum sensor may measure a physical phenomenon that is entirely different than the target physical phenomenon. For example, the target quantum state may comprise energy of a molecule, while the quantum sensor may measure a magnetic field.

In some exemplary embodiments, even in case the quantum sensor measures the same physical phenomenon that is measured by the target quantum state, the quantum sensor may not have access to the full quantum state of the physical phenomenon. In some cases, the quantum sensor may not be enabled to fully measure the energy of the molecule at a certain time, and instead may be capable of measuring one or more specific attributes or properties associated with the energy of the molecule. For example, the target quantum state may comprise energy of a molecule, while the quantum sensor may measure a property of the same molecule (e.g., at the same or different time) such as its structure or angle.

In some exemplary embodiments, the measurable attributes of the physical phenomenon may be represented by a first set of one or more parameters, while the full quantum state of the physical phenomenon may be represented by a second set of one or more parameters. In some exemplary embodiments, the first set of parameters may comprise a sub-set of the second set of parameters, may comprise a disjoint set of parameters, or may have some overlap with the first set of parameters. For example, the first set of parameters may comprise a first parameter that is included in the second set of parameters, and a second parameter that is not included in the second set of parameters. In some cases, the first set of one or more parameters may represent properties of a different physical phenomenon than the second set of one or more parameters.

In some exemplary embodiments, the sensed quantum state that is measured by the quantum sensor may be loaded and fed to a set of one or more qubits of a quantum computer. In some exemplary embodiments, the set of qubits may belong to a parametric quantum circuit, such as Quantum Circuit 110 of FIG. 1A. For example, the set of qubits may belong to an ansatz parametric circuit such as ansatz parametric circuit 104 of FIG. 1A.

In some exemplary embodiments, instead of designing the ansatz parametric circuit to comprise a circuit that is initialized with random states, arbitrary states, or with zero states (e.g., ground states), at least some qubits of the ansatz parametric circuit may be initialized with the sensed quantum state measured by the quantum sensor. For example, a defined set of one or more qubits may be set with the sensed quantum state. In some exemplary embodiments, the initial quantum state of the defined set of qubits may be provided by the quantum sensor, such as by loading the sensed quantum state to the defined set of qubits. In some exemplary embodiments, the defined set of qubits may comprise a subset of the input qubits of the ansatz parametric circuit, all of the input qubits of the ansatz parametric circuit, or the like.

In some exemplary embodiments, the ansatz parametric circuit may be designed to manipulate an initial state of the qubits with one or more sub-circuits, gates, quantum operations, or the like. In some exemplary embodiments, the ansatz parametric circuit may comprise a set of quantum gates that evolve an initial quantum state at one or more initial cycles of the qubits, to a manipulated state encoding an output of the circuit, such as in accordance with the ansatz.

In some exemplary embodiments, during at least some VQE iterations, the VQE iterations may encompass measuring one or more sensed quantum states by the quantum sensor and loading the sensed quantum states to the set of qubits. For example, the sensed quantum states may measure a same physical phenomenon every iteration, a different physical phenomenon, or the like. In some cases, the physical phenomenon measured by the quantum sensor may be reset every iteration.

In some exemplary embodiments, by feeding the sensed quantum state to at least some of the input qubits of the ansatz parametric circuit, the ansatz parametric circuit may have a better starting point for the VQE iterations compared to starting with a random state, an arbitrary state, a zero state, or the like. For example, since the sensed quantum state is associated to at least one property of an actual physical system, unlike arbitrary or zero states, the sensed state may be more similar to the full quantum state of the physical phenomenon, thus reducing the number of VQE iterations that are needed until convergence. In some exemplary embodiments, even if the sensed quantum state measures a different phenomenon from the target physical phenomenon, the sensed quantum state may still constitute a complex quantum state that serves as a better starting point for the VQE iterations than a random state, a zero state, or the like.

In some exemplary embodiments, after loading the sensed quantum state to the set of qubits of the ansatz parametric circuit, the sensed quantum state of the set of qubits may be manipulated by the ansatz parametric circuit, and the manipulated sensed quantum state may be fed to the assessing module (e.g., corresponding to Assessing Module 145 of FIG. 1A).

In some exemplary embodiments, the quantum circuit, including the ansatz parametric circuit and the assessing module, may be executed, e.g., on a quantum computer, quantum cloud, or the like. In some exemplary embodiments, the execution output may be measured, and the ansatz parameters may be adjusted accordingly. In some exemplary embodiments, the ansatz parameters may be adjusted in order to find a minimum eigenvalue, or expectation value, from the assessing module. In some cases, upon finding the minimal expectation value, the VQE iterations may terminate, e.g., according to the flow of FIG. 1B.

In some exemplary embodiments, the quantum circuit (e.g., the assessing module within the circuit) may output a single output state via a single qubit, may output one or more output states via two or more qubits, or the like. For example, the output of the quantum circuit may correspond to the output from the assessing module, and may indicate an expectation value of the manipulated state that is fed to the assessing module from the ansatz parametric circuit.

Referring now to FIG. 1B, depicting an exemplary schematic block diagram, in accordance with some exemplary embodiments of the disclosed subject matter.

In some exemplary embodiments, Block Diagram 101 may depict a VQE framework that is configured to approximate a full quantum state of a first physical phenomenon, that cannot be measured directly. In some exemplary embodiments, Block Diagram 101 may correspond to Block Diagram 100 of FIG. 1A, and its subcomponents may correspond to the subcomponents of Block Diagram 100 of FIG. 1A. In some cases, Block Diagram 101 may comprise one or more additional components that are not included in Block Diagram 100, such as a quantum sensor (Quantum Sensor 102).

As depicted in FIG. 1B, a flow of Block Diagram 101 starts with Quantum Sensor 102 measuring one or more properties of a second physical phenomenon, object, system, or the like. In some exemplary embodiments, Quantum Sensor 102 may load the measured properties, as a quantum state, on a set of one or more qubits of VQE Ansatz 104. In some exemplary embodiments, VQE Ansatz 104 may be comprised within Quantum Circuit 110. In some exemplary embodiments, Loaded Sensor Data 141 may comprise a set of qubits of VQE Ansatz 104 that are initialized with the quantum state from Quantum Sensor 102. For example, Loaded Sensor Data 141 may represent the set of qubits holding the quantum state from Quantum Sensor 102. In some cases, Loaded Sensor Data 141 may be absent of any logical gates.

In some exemplary embodiments, subsequently to loading the set of qubits with the sensed quantum state, Loaded Sensor Data 141 may be manipulated by a preprocessing stage, a processing stage, a post-processing stage, or the like, e.g., incorporated within Processing 143 stage. In some exemplary embodiments, Processing 143 may comprise a sub-circuit of VQE Ansatz 104, which may apply one or more quantum gates, operations, manipulations, or the like, on one or more initial states of the set of qubits. For example, Processing 143 may manipulate the sensed quantum state. In some exemplary embodiments, Processing 143 may incorporate a pre-processing stage which may be implemented before Loaded Sensor Data 141, before Quantum Sensor 102 loads a quantum state on qubits of Quantum Circuit 110, or the like. In some exemplary embodiments, the pre-processing stage may comprise one or more manipulations, gates, quantum operations, or the like, which may be applied to a same set of qubits as Loaded Sensor Data 141, to a different set of qubits, to a set of qubits that has some overlapping qubits with Loaded Sensor Data 141, or the like. For example, the pre-processing stage may apply one or more computations on a first set of qubits, after which Quantum Sensor 102 may load a quantum state on a second, potentially disjoint set of qubits, after which a processing stage may manipulate both first and second sets of qubits.

In some exemplary embodiments, Processing 143 may be designed to implement an ansatz attempting to approximate the full quantum state of the first physical phenomenon. In some exemplary embodiments, Processing 143 may apply one or more quantum operations to Loaded Sensor Data 141, and generate a processed version of the initial quantum state, e.g., a processed version of the sensed quantum state.

In some exemplary embodiments, the processed version of the sensed quantum state may be provided to Assessing Module 145. In some exemplary embodiments, Assessing Module 145 may comprise a problem-specific module, which may be specifically tailored to measure or determine an operator on a quantum state from VQE Ansatz 104. For example, Assessing Module 145 may be generated and/or designed locally on the quantum computer, obtained from a third party, or the like. In some exemplary embodiments, Assessing Module 145 may or may not be configured to be adjusted between one or more VQE iterations, between one or more executions of Quantum Circuit 110, or the like.

In some exemplary embodiments, Assessing Module 145 may assess the expectation values of an operator, such as an energy operator, on VQE Ansatz 104. For example, Assessing Module 145 may determine the energy of an output from VQE Ansatz 104. In some exemplary embodiments, Assessing Module 145 may output an indication, such as a non-binary indication of the expectation value (e.g., the energy).

In some exemplary embodiments, Quantum Circuit 110 may be executed by Execute 106, causing Loaded Sensor Data 141 to be manipulated by Processing 143 (e.g., the pre-processing stage thereof, the processing stage thereof, or the like) and Assessing Module 145. In some exemplary embodiments, the execution results, corresponding to the expectation value determined by Assessing Module 145, may be measured by Measure 108. For example, Execute 106 may execute Quantum Circuit 110 once, a plurality of times, or the like. In some cases, Measure 108 may measure an output state of the execution using tomography measurements, or using any other measurement, estimation, approximation, or prediction technique.

In some exemplary embodiments, based on the measurements, parameter values of Processing 143 may be adjusted, thereby implementing an iterative VQE scheme. For example, valuations of the ansatz parameters may be adjusted, the pre-processing stage may be adjusted, or the like. In some exemplary embodiments, the valuations of the set of ansatz parameters associated with Processing 143 may be adjusted iteratively as part of a VQE, thereby providing different valuations to the parameters every one or more iterations. In some exemplary embodiments, different variations of Assessing Module 145 may be executed at different executions of Quantum Circuit 110, different VQE iterations, or the like. In some exemplary embodiments, adjustments of sub-circuits of Quantum Circuit 110 may be determined by a classical processing unit, such as by Measure 108.

In some exemplary embodiments, after each assessment and measurement, the VQE iteration may be terminated, and a new VQE iteration with a modified ansatz parametric circuit may be implemented. In some exemplary embodiments, the iterations may be executed for different logical variations of logical ansatz parameters associated with Processing 143, for different variations of Assessing Module 145, or the like. For example, the ansatz parametric circuit may be modified by modifying an angle of the gates of the ansatz parametric circuit between VQE iterations.

In some exemplary embodiments, the valuations for the set of parameters may be selected or determined to adjust values in a defined order, random values, values selected by a greedy search algorithm, values selected by a non-greedy search algorithm, or the like. In some cases, during a single VQE iteration, Quantum Circuit 110 may be executed a plurality of times for different variations of Assessing Module 145, and new valuations of parameters for VQE Ansatz 104 may be determined and assigned based on execution results. In some exemplary embodiments, for each valuation of the set of ansatz parameters, the quantum computer may be configured to execute a respective version of Quantum Circuit 110 resulting from the selected valuation. For example, a classical processor such as Measure 108 may update the parameters of Processing 143 iteratively, until the VQE algorithm converges (e.g., resulting with a minimal amount of energy for an energy operator).

In some exemplary embodiments, every iteration, or during at least some iterations, Quantum Sensor 102 may be configured to re-measure the properties of the second physical phenomenon, object, system, or of any other physical phenomenon. In some exemplary embodiments, Quantum Sensor 102 may iteratively load the measured properties as a quantum state on the set of qubits of Quantum Circuit 110. In some cases, the physical object measured by Quantum Sensor 102 may or may not be set every iteration to a same state, position, or the like.

In some exemplary embodiments, Quantum Circuit 110 may be executed iteratively using the newly loaded sensed data as the initial state of the set of qubits. In some exemplary embodiments, the VQE iterations may continue until convergence, which may occur when Assessing Module 145 outputs an expectation value that is the minimal value of a target function, e.g., the energy operator, or any other desired value or state. For example, convergence may be reached when finding a minimum eigenvalue, e.g., a minimal numerical quantity that characterizes a particular property of the first physical phenomenon. As another example, convergence may be reached when finding the minimum expectation value of an energy operator, corresponding to the optimal configuration or ground state energy of the first physical phenomenon.

In some exemplary embodiments, upon convergence, the measured expectation value that is determined based on measurements of the last VQE iteration, may be determined to correspond to the full quantum state of the first physical phenomenon. For example, the measured expectation value may be stored as an approximation of the target quantum state, provided to one or more entities, or the like. For example, in case the target quantum state is energy of a molecule, a plurality of iterations of VQE may execute Quantum Circuit 110 with different valuations of ansatz parameters. According to this example, the iterations may terminate when, at a last iteration, Assessing Module 145 outputs a minimal eigenvalue, a desired eigenvalue, or the like. In such cases, the minimal eigenvalue may represent the minimal energy of the molecule, which may correspond to the actual energy of the molecule at a certain time, being, by nature, the lowest possible.

It is noted that a single iteration may comprise a single execution of Quantum Circuit 110, a plurality of executions of Quantum Circuit 110, or the like. In some exemplary embodiments, during one or more iterations, the ansatz parameters defining the structure of Processing 143 may be adjusted, a pre-processing stage of Processing 143 may be adjusted, the Assessing Module 145 may be adjusted, or the like. In some exemplary embodiments, measurements of outputs from Quantum Circuit 110 may be used, by a classical processor, to update the ansatz parameters of Processing 143 iteratively, until Assessing Module 145 detects the optimal set of parameters for Processing 143, that results with a minimal eigenvalue, a desired eigenvalue, or the like. For example, the parameters of Processing 143 may be updated iteratively until Assessing Module 145 determines a lowest amount of energy.

One technical effect obtained by the disclosed subject matter is enabling to approximate a quantum state of a physical phenomenon, while reducing a number of iterations that are required for identifying the approximation. For example, the number of iterations may be reduced at least compared to the number of iterations required for implementing the naïve method. In some cases, reducing the number of iterations may reduce incurred computational costs, communication overhead, storage costs, or the like. In some exemplary embodiments, by initializing the ansatz parametric circuit with sensed quantum states at each VQE iteration, the ansatz parametric circuit may have a better starting point compared to random or zero states. For example, since a sensed quantum state may be more similar to the target quantum state than a random value or an arbitrary value, the convergence of the VQE technique may be swifter than the naïve method.

The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

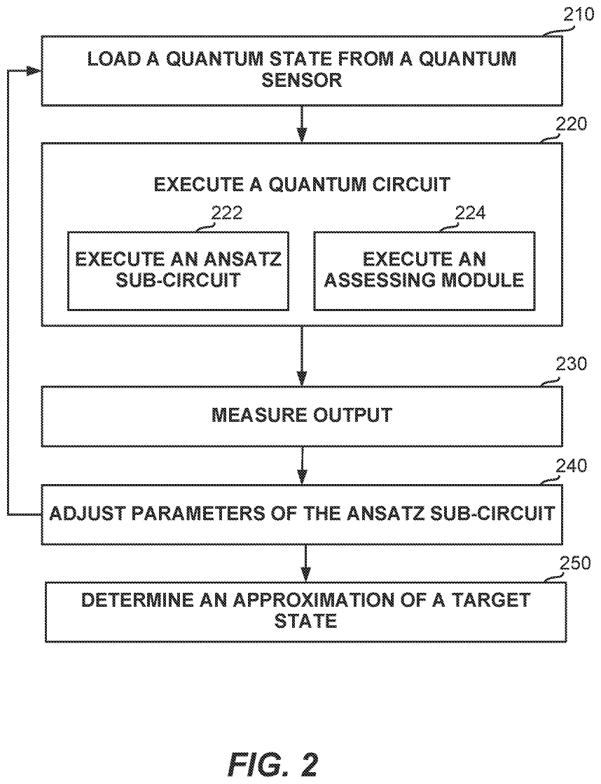

Referring now to FIG. 2, showing an exemplary flowchart diagram of a method, in accordance with some exemplary embodiments of the disclosed subject matter.

On Step 210, a quantum state measured by a quantum sensor may be loaded to one or more qubits of a quantum computer.

In some exemplary embodiments, the quantum sensor may be configured to measure at least one property of a first physical phenomenon, e.g., a physical phenomenon, object, or the like. For example, the quantum sensor may be configured to measure a magnetic field of an atom, a location of an atom, a speed of an atom, energy of a molecule, a magnetic field of a molecule, a location of a molecule, a speed of a molecule, a quantum state of a physical situation, quantum information processing, quantum information measuring, or the like.

In some exemplary embodiments, the quantum sensor may be configured to load the measured property of the first physical phenomenon, such as a quantum property thereof, as a quantum state, on one or more qubits of a quantum computer. In some exemplary embodiments, the sensed quantum state may represent the property of the first physical phenomenon, correspond thereto, or the like.

In some exemplary embodiments, the quantum computer may be connectable to the quantum sensor via one or more mediums, e.g., physical connections, wireless connections, or the like, which may be quantum or classical. In some exemplary embodiments, the one or more mediums may enable the quantum computer to receive the quantum state from the quantum sensor. For example, the quantum sensor may load the sensed quantum state on one or more qubits of the quantum computer via the one or more mediums.

In some cases, the quantum sensor and quantum computer may be housed in a single physical device, in separate physical devices, or the like. In case they are housed in a single physical device, the quantum computer may constitute an on-sensor embedded quantum computer. For example, an on-sensor embedded quantum computer may comprise a quantum computer that is embedded directly onto a quantum sensor. According to this example, the integration of the quantum computer with the quantum sensor may enhance a data acquisition process of the sensed quantum state. In other cases, the quantum sensor and quantum computer may be housed in separate devices, and connected via a medium such as a wire.

In some exemplary embodiments, the quantum computer may receive the quantum state by loading the quantum state on one or more qubits of the quantum computer. For example, the quantum state may be loaded on a subset of the qubits of the quantum computer, on all of the qubits of the quantum computer, or the like. In some exemplary embodiments, the quantum state may be loaded as an initial state of the one or more qubits with respect to a quantum circuit.

In some exemplary embodiments, the set of one or more qubits that is loaded with the quantum state, may be part of a parametric quantum circuit. In some exemplary embodiments, the set of one or more qubits may be set to represent the quantum state at an initial cycle of the parametric quantum circuit, at an intermediate cycle of the parametric quantum circuit, or the like.

On Step 220, the parametric quantum circuit may be executed by the quantum computer. In some exemplary embodiments, the quantum computer may be configured to execute the parametric quantum circuit once, a plurality of times, or the like. In some exemplary embodiments, as the number of executions increases, the accuracy of the output estimations may increase. For example, every VQE iteration, the quantum computer may be configured to execute the parametric quantum circuit a plurality of times.

In some exemplary embodiments, executing the parametric quantum circuit may comprise executing sub-circuits thereof such as a pre-processing circuit incorporated in the parametric quantum circuit, an ansatz parametric circuit that is incorporated in the parametric quantum circuit, an assessing module that is incorporated in the parametric quantum circuit, or the like. In some exemplary embodiments, the parametric quantum circuit may be designed to comprise the ansatz parametric circuit and the assessing module, consecutively. In case the pre-processing stage is implemented, it may be incorporated before the ansatz parametric circuit, at one or more overlapping cycles, or the like. For example, the parametric quantum circuit may be executed according to Steps 222-224.

On Step 222, an ansatz parametric circuit, comprised within the parametric quantum circuit, may be executed. For example, the ansatz parametric circuit may be executed before the assessing module is executed, at one or more overlapping cycles, or the like.

In some exemplary embodiments, the ansatz parametric circuit may implement an ansatz. In some exemplary embodiments, the ansatz may comprise a hypothesis or assumption associated with a target quantum state of a second physical phenomenon, e.g., different or identical to the first physical phenomenon. In some exemplary embodiments, the target quantum state of the second physical phenomenon may be representable by one or more parameters.

In some exemplary embodiments, the first and second physical phenomena may be different from one another, identical to one another, or the like. In some cases, the first and second physical phenomena may belong to a same category of physical objects, e.g., a magnetic field of an atom, a property of a molecule, or the like, but may comprise different physical objects. For example, both the first and second physical phenomena may comprise a magnetic field of an atom, but each one may correspond to a different atom, a different type of atom, or the like. As another example, both the first and second physical phenomena may comprise a magnetic field of a same atom at a same time, position, or the like. As another example, the first and second physical phenomena may comprise different physical phenomena belonging to different categories.

In some exemplary embodiments, the property of the first physical phenomenon that is measured by the quantum sensor may represent a portion of the target quantum state of the second physical phenomenon. For example, the property of the first physical phenomenon may comprise one parameter associated with the magnetic field of an atom, while the target quantum state of the second physical phenomenon may comprise a full set of parameters representing the magnetic field of the atom. In some exemplary embodiments, the property of the first physical phenomenon that is measured by the quantum sensor may not represent any portion of the target quantum state of the second physical phenomenon. For example, the property of the first physical phenomenon may comprise one or more parameters associated with the magnetic field of an atom, while the target quantum state of the second physical phenomenon may comprise a set of parameters representing a location of a molecule. As another example, the property of the first physical phenomenon may comprise one or more first parameters associated with a magnetic field of an atom, while the target quantum state of the second physical phenomenon may comprise one or more second, at least partially disjoint, parameters representing the same magnetic field of the atom.

In some exemplary embodiments, the ansatz parametric circuit may be designed, prepared, generated, obtained from a remove location, or the like. For example, the ansatz parametric circuit may comprise a physics-oriented ansatz, a hardware-oriented ansatz, or any other ansätze and parameters disclosed in M. Cerezo. In some exemplary embodiments, at least a subset of the qubits of the ansatz parametric circuit may be fed with the sensed quantum state from the quantum sensor.

In some exemplary embodiments, the ansatz parametric circuit may be associated to a set of parameters. In some exemplary embodiments, the ansatz parametric circuit may belong to a parameterized family of quantum circuits that can be adjusted by tuning their set of parameters. In some exemplary embodiments, since the ansatz parametric circuit is parametric, the ansatz parametric circuit may have tunable parameters defining certain gates or portions of the circuit. For example, the ansatz parametric circuit may comprise a quantum circuit in which at least some of the gates are defined by parameters that are initially unspecified, constitute variables, or the like. In some exemplary embodiments, allowing certain gates or portions of the ansatz parametric circuit to have tunable parameters may introduce flexibility to the ansatz parametric circuit.

In some exemplary embodiments, the ansatz may be designed to approximate to the target quantum state (e.g., under a defined accuracy threshold) when using a certain valuation of the set of parameters. In some exemplary embodiments, the set of parameters may comprise any property or parameter that can affect the ansatz parametric circuit, such as parameters defining angles of rotation gates, which gate to include or exclude, or the like. In some cases, parameters of the ansatz parametric circuit may correspond to ones disclosed in Harper R. Grimsley et al. An adaptive variational algorithm for exact molecular simulations on a quantum computer. arXiv: 1812.11173. Nature Communications 10, 3007 (2019). arxiv.org/abs/1812.11173, which is hereby incorporated by reference in its entirety for all purposes without giving rise to disavowment.

In some exemplary embodiments, the ansatz parametric circuit may be configured to simulate the second physical phenomenon, one or more properties thereof, or the like, such that the simulation corresponds to the target quantum state. In some cases, the ansatz parametric circuit may be predicted or estimated to have at least one set of valuations to the set of parameters, that, when applied to the parameters, provides an approximation, simulation, or the like, of a state of the second physical phenomenon. For example, in case the target state of the second physical phenomenon is measuring energy of a molecule, the ansatz parametric circuit may be designed to have at least one set of valuations to the set of parameters that provides a quantum state of the molecule, having the energy of the molecule.

In some exemplary embodiments, the set of parameters associated with the ansatz parametric circuit may be set with one or more valuations, which may represent corresponding ansatz parametric circuits. For example, the ansatz parametric circuit represented by the one or more valuations may be generated to comprise different angles of rotation gates according to the valuations. In some exemplary embodiments, the ansatz parametric circuit may be configured to manipulate the sensed quantum state of the one or more qubits using one or more quantum operations, gates, or the like. For example, a first ansatz parametric circuit that is constructed according to a first valuation of the set of parameters, may manipulate the sensed quantum state differently from a second ansatz parametric circuit that is constructed according to a second valuation of the set of parameters.

In some exemplary embodiments, the ansatz parametric circuit may be configured to apply one or more quantum operations on the qubits that hold the sensor's quantum state, and output a processed version of the sensor's quantum state. In some exemplary embodiments, after the set of qubits is manipulated by the ansatz parametric circuit, the set of qubits may hold one or more manipulated or processed quantum states.

In some exemplary embodiments, at least one manipulated quantum state that is provided by the ansatz parametric circuit may or may not simulate, represent, or correspond to the second physical phenomenon.

On Step 224, an assessing module, comprised within the parametric quantum circuit, may be executed. For example, the assessing module may be executed after the ansatz parametric circuit is executed, at one or more overlapping cycles, or the like. In some cases, the assessing module may be external to the ansatz quantum circuit. In some cases, the assessing module may be generated locally on the quantum computer, obtained from a remote entity, or the like.

In some exemplary embodiments, the assessing module may be designed to assess the at least one manipulated quantum state that is provided from the ansatz parametric circuit. For example, the assessing module may assess a target operator, such as an energy operator, that is represented by the manipulated quantum state. In some exemplary embodiments, the assessing module may assess or evaluate one or more expectation values of an operator (e.g., an energy operator) on the ansatz quantum circuit. In some exemplary embodiments, the assessing module may be configured to output an indication of an expectation value, a measured expectation value, a normalized expectation value, or the like. For example, the assessing module may output the energy that corresponds to the manipulated quantum state from the ansatz quantum circuit. In some cases, the assessing module may be configured to output, every one or more iterations, circuit executions, or the like, a different part of an expectation value. In such cases, multiple iterations may be required in order to reconstruct a full assessment of the expectation value.

On Step 230, an output from the execution of the quantum circuit may be measured. For example, the expectation value, or portion thereof, provided from the assessing module may correspond to an output of the execution of the quantum circuit, and may be measured using tomography measurements, or using any other measurement, estimation, approximation, or prediction technique.

In some exemplary embodiments, Steps 220-230 may be performed a plurality of times, separately or in addition to Step 210. In some exemplary embodiments, based on one or more measurements of Step 230, a determination may be made whether the expectation value provided from the assessing module corresponds to the target quantum state, in which case the flow of the method may continue to Step 250, skipping Step 240. Otherwise, Step 240 may be implemented. For example, the expectation value provided from the assessing module may be determined to correspond to the target quantum state in case that the expectation value is the minimal value of a target function. As another example, the expectation value provided from the assessing module may be determined to correspond to the target quantum state in case that the expectation value is a minimal expectation value of a target operator, e.g., resulting with an approximation of the ground state energy of the molecular system for an energy operator. As another example, the expectation value provided from the assessing module may be determined to correspond to the target quantum state in case that the expectation value constitutes a minimum eigenvalue.

On Step 240, valuations of the set of parameters of the ansatz parametric circuit may be adjusted based on the measurements of Step 230. For example, valuations of the set of parameters of the ansatz parametric circuit may be adjusted based on a plurality of circuit executions and measurements of Steps 220-230, Steps 210-230, or the like.

In some exemplary embodiments, the quantum computer, alone or in combination with one or more classical processing units, may be configured to implement a VQE scheme to iteratively adjust one or more values of the set of parameters defining the ansatz parametric circuit, to adjust properties of the assessing module, or the like. In some exemplary embodiments, every one or more VQE iterations, values of the set of parameters may be adjusted, and Steps 210-230 may be performed a plurality of times. In some exemplary embodiments, the parameter values may be adjusted until the ansatz parametric circuit is determined, by the assessing module, to output a quantum state that causes the assessing module to output a minimal expectation value, a desired expectation value, or the like.

In some exemplary embodiments, the values of the parameters may be configured to be adjusted between one or more iterations of the VQE scheme, e.g., manually by a user, automatically such as by a search algorithm, or the like. For example, the parameters may be configured to be adjusted between iterations according to a binary search algorithm.

In some exemplary embodiments, a state of the first physical phenomenon that is measured by the quantum sensor, may be reset between one or more iterations of the VQE scheme. In other cases, the first physical phenomenon may be measured every iteration without resetting its state. In other cases, different physical phenomena may be measured every iteration.

In some exemplary embodiments, every iteration of the VQE scheme, or during at least some iterations, the one or more qubits may be initialized with sensed quantum states measured by the quantum sensor.

In some exemplary embodiments, after initializing the states of the one or more qubits, and adjusting the parameters that define the parametric quantum circuit (e.g., its ansatz parametric circuit), the quantum computer may execute the resulting parametric quantum circuit, which may differ for different valuations of ansatz parameters. In some exemplary embodiments, the quantum computer may execute the adjusted parametric quantum circuit with different valuations of the set of parameters a plurality of times, e.g., every one or more iterations of the VQE scheme. In some exemplary embodiments, the parametric quantum circuit may be executed a plurality of times for a single iteration of the VQE scheme, a single time for a single iteration, or the like. In some exemplary embodiments, outputs from the parametric quantum circuit may be measured every execution. In some exemplary embodiments, performing a plurality of executions and measurements may enable to estimate the result of the assessing module, and infer based thereon whether the valuation of the parameters of the ansatz parametric circuit was an optimal valuation.

On Step 250, an approximation of the target quantum state may be determined, generated, or the like, based on the output of the parametric quantum circuit.

In some exemplary embodiments, after determining that a valuation of the parameters of the ansatz parametric circuit in the last VQE iteration resulted with an optimal expectation value, the VQE iterations may terminate, and the expectation value that was lastly measured may be determined to represent, or comprise, an approximation of the target quantum state of the second physical phenomenon.

In some exemplary embodiments, the approximation of the target quantum state may be provided, e.g., by an output module, to a quantum computer, a classical computer, or the like. In some exemplary embodiments, the approximation may be transmitted in a non-quantum communication channel, e.g., via a classical communication channel such as WIFI™.

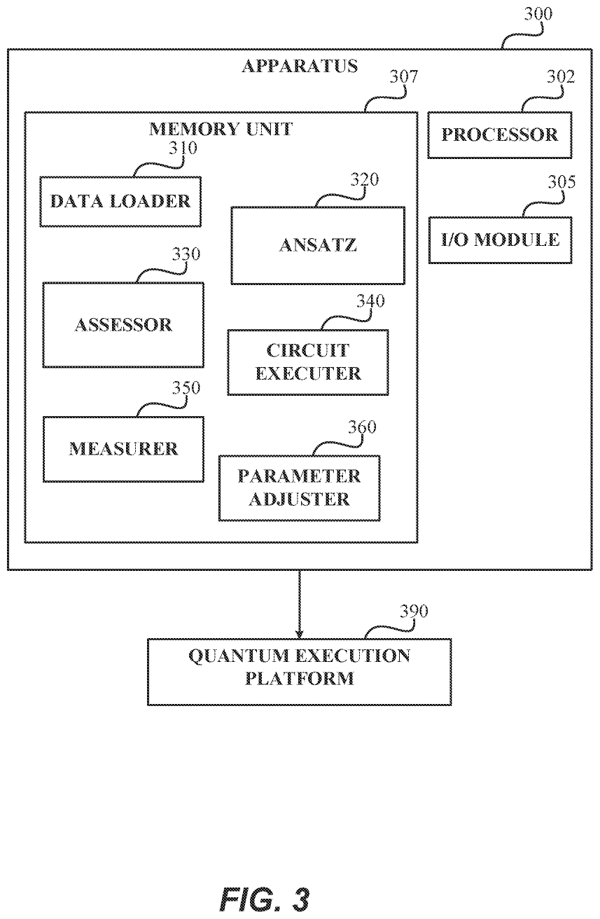

Referring now to FIG. 3 showing a block diagram of an apparatus, in accordance with some exemplary embodiments of the disclosed subject matter.

In some exemplary embodiments, Apparatus 300 may comprise one or more Processor(s) 302. Processor 302 may be a Central Processing Unit (CPU), a microprocessor, an electronic circuit, an Integrated Circuit (IC) or the like. Processor 302 may be utilized to perform computations required by Apparatus 300 or any of its subcomponents. It is noted that Processor 302 may be a traditional processor, and not necessarily a quantum processor.

In some exemplary embodiments of the disclosed subject matter, Apparatus 300 may comprise an Input/Output (I/O) module 305. I/O Module 305 may be utilized to provide an output to and receive input from a user, an apparatus, or the like, such as, for example to communicate with quantum hardware, to communicate with a remote quantum computer, to communicate with a classical computer, or the like.

In some exemplary embodiments, Apparatus 300 may comprise Memory 307. Memory 307 may be a hard disk drive, a Flash disk, a Random Access Memory (RAM), a memory chip, or the like. In some exemplary embodiments, Memory 307 may retain program code operative to cause Processor 302 to perform acts associated with any of the subcomponents of Apparatus 300. Memory 307 may comprise one or more components as detailed below, implemented as executables, libraries, static libraries, functions, or any other executable components.

In some exemplary embodiments, Memory 307 may comprise a Data Loader 310. Data Loader 310 may be configured to load at least one quantum state from a quantum sensor on one or more qubits. In some exemplary embodiments, the quantum state may represent a quantum property of a first physical phenomenon measured by the quantum sensor.

In some exemplary embodiments, Memory 307 may comprise an Ansatz 320 (e.g., corresponding to VQE Ansatz 104 of FIG. 1B and to Step 222 of FIG. 2), which may be configured to attempt to approximate a full quantum state of a second physical phenomenon, e.g., different or same as the first physical phenomenon. For example, Ansatz 320 may comprise a sub-circuit that manipulates the sensed quantum state of the one or more qubits according to a determined ansatz and associated parameter values, under the assumption that a valuation of the parameters exists such that the sub-circuit approximates or simulates a state of the second physical phenomenon.

In some exemplary embodiments, Memory 307 may comprise an Assessor 330 (e.g., corresponding to Assessing Module 145 of FIG. 1B and to Step 224 of FIG. 2), which may be configured to obtain a manipulated quantum state from Ansatz 320, and assess one or more expectation values of an operator (e.g., an energy operator) on Ansatz 320.

In some exemplary embodiments, Memory 307 may comprise a Circuit Executer 340, which may be configured to execute a parametric quantum circuit that comprises Ansatz 320 and Assessor 330, and is initialized by Data Loader 310. For example, Circuit Executer 340 may execute the parametric quantum circuit on Quantum Execution Platform 390 a plurality of time for each valuation of parameters, a single time for each valuation of parameters, or the like. In some exemplary embodiments, Quantum Execution Platform 390 may comprise at least one quantum computer, at least one quantum computing cloud, a combination thereof, or the like. In some cases, Circuit Executer 340 may execute different variations of Assessor 330 during one or more different executions.

In some exemplary embodiments, Memory 307 may comprise a Measurer 350, which may be configured to measure one or more executions of Circuit Executer 340. For example, Measurer 350 may measure a plurality of executions of Circuit Executer 340. In some exemplary embodiments, Measurer 350 may determine whether one or more expectation values determined by Assessor 330, as outputted from the execution, comprise a minimal expectation value. In case the output from the executions is determined not to comprise a minimal expectation value, Measurer 350 may provide the output to Parameter Adjuster 360, for implementing a VQE iteration. In case the output from the executions does comprise a minimal or desired expectation value, Measurer 350 may output the expectation value, and no further VQE iterations may be implemented. In some cases, the expectation value may be communicated, via a classical medium such as I/O Module 305, to one or more classical computers, remote quantum computers, or the like.

In some exemplary embodiments, Memory 307 may comprise a Parameter Adjuster 360, which may be configured to obtain an outcome of measurements by Measurer 350, and based thereon determine how to adjust parameters of Ansatz 320. For example, in case Assessor 330 indicates that Ansatz 320 did not provide a sufficient representation or simulation of the target quantum state, e.g., in case Assessor 330 provides non-minimized expectation values of an operator (e.g., an energy operator) on Ansatz 320, Parameter Adjuster 360 may adjust parameters of Ansatz 320 to values that are estimated to cause Assessor 330 to measure a reduced expectation value of the operator on Ansatz 320. In some exemplary embodiments, using the adjusted parameters, a new variation of Ansatz 320 may be generated, and a new VQE iteration may be implemented.

The present disclosed subject matter may be a system, a method, and/or a computer program product. The computer program product may include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), electrical signals transmitted through a wire, Quantum Random Access Memory (QRAM), photons, trapped ions, lasers, cold atoms, or the like.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server (or a group of multiple remote servers). In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A system comprising:
a quantum sensor that is configured to measure at least one property of a first physical phenomenon;
a quantum computer that is connectable to said quantum sensor, said quantum computer is configured to execute a parametric quantum circuit, wherein the parametric quantum circuit comprises one or more qubits that are set, by said quantum sensor, with a sensed quantum state, the sensed quantum state representing the at least one property of the first physical phenomenon,
wherein the parametric quantum circuit comprises:
an ansatz parametric circuit implementing an ansatz, wherein the ansatz parametric circuit is configured to approximate a target quantum state of a second physical phenomenon, the ansatz parametric circuit is configured to manipulate the sensed quantum state of the one or more qubits, thereby outputting at least one manipulated quantum state; and
an assessing module configured to obtain the at least one manipulated quantum state from the ansatz parametric circuit, and to assess an expectation value of one or more operators on the at least one manipulated quantum state;
wherein said quantum computer is configured to implement a Variational Quantum Eigensolver (VQE) scheme to iteratively adjust one or more values of a set of parameters defining the ansatz parametric circuit until the assessing module provides a desired expectation value; and
an output module configured to output the desired expectation value.

2. The system of claim 1, wherein the first physical phenomenon is different from the second physical phenomenon.

3. The system of claim 2, wherein the first physical phenomenon and the second physical phenomenon belong to a same category of physical objects.

4. The system of claim 1, wherein the first physical phenomenon and the second physical phenomenon are identical phenomena.

5. The system of claim 1, wherein said system is configured to reset a state of the first physical phenomenon between iterations of the VQE scheme.

6. The system of claim 1, wherein said system is configured to load the one or more qubits with sensed quantum states measured by said quantum sensor every iteration of the VQE scheme.

7. The system of claim 1, wherein said quantum computer is configured to execute the parametric quantum circuit with different valuations of the set of parameters every iteration of the VQE scheme, thereby executing different ansatz parametric circuits every iteration of the VQE scheme.

8. The system of claim 7, wherein said execute comprises executing the parametric quantum circuit a plurality of times for a single iteration of the VQE scheme.

9. The system of claim 1, wherein said system is configured to measure one or more outputs from executions of the parametric quantum circuit and adjust valuations of the set of parameters based on the one or more outputs.

10. The system of claim 1, wherein said quantum sensor and quantum computer are housed in a single physical device, whereby the quantum computer is an on-sensor embedded quantum computer.

11. The system of claim 1, wherein said output module is configured to provide the desired expectation value to at least one of a quantum computer and a classical computer.

12. The system of claim 1, wherein the at least one property comprises a quantum property of the first physical phenomenon.

13. The system of claim 1, wherein the desired expectation value comprises a minimal expectation value.

14. An apparatus comprising a processor and coupled memory, said processor being adapted to:
measure at least one property of a first physical phenomenon, said measure is performed by a quantum sensor;
execute a parametric quantum circuit at a quantum computer that is connectable to said quantum sensor, wherein the parametric quantum circuit comprises one or more qubits that are set, by said quantum sensor, with a sensed quantum state, the sensed quantum state representing the at least one property of the first physical phenomenon, wherein the parametric quantum circuit comprises:
an ansatz parametric circuit implementing an ansatz, wherein the ansatz parametric circuit is configured to approximate a target quantum state of a second physical phenomenon, the ansatz parametric circuit is configured to manipulate the sensed quantum state of the one or more qubits, thereby outputting at least one manipulated quantum state; and
an assessing module configured to obtain the at least one manipulated quantum state from the ansatz parametric circuit, and to assess an expectation value of one or more operators on the at least one manipulated quantum state;
implement, at said quantum computer, a Variational Quantum Eigensolver (VQE) scheme to iteratively adjust one or more values of a set of parameters defining the ansatz parametric circuit until the assessing module provides a desired expectation value; and
output the desired expectation value.

15. The apparatus of claim 14, wherein the first physical phenomenon is different from the second physical phenomenon.

16. The apparatus of claim 14, wherein the first physical phenomenon and the second physical phenomenon are identical phenomena.

17. The apparatus of claim 14, wherein said quantum computer is configured to execute the parametric quantum circuit with different valuations of the set of parameters every iteration of the VQE scheme, thereby executing different ansatz parametric circuits every iteration of the VQE scheme, wherein said execute comprises executing the parametric quantum circuit a plurality of times for a single iteration of the VQE scheme.

18. The apparatus of claim 14, wherein said processor is adapted to measure one or more outputs from executions of the parametric quantum circuit and adjust valuations of the set of parameters based on the one or more outputs.

19. The apparatus of claim 14, wherein the desired expectation value comprises a minimal expectation value.

20. A computer program product comprising a non-transitory computer readable medium retaining program instructions, which program instructions when read by a processor, cause the processor to:
measure at least one property of a first physical phenomenon, said measure is performed by a quantum sensor;
execute a parametric quantum circuit at a quantum computer that is connectable to said quantum sensor, wherein the parametric quantum circuit comprises one or more qubits that are set, by said quantum sensor, with a sensed quantum state, the sensed quantum state representing the at least one property of the first physical phenomenon, wherein the parametric quantum circuit comprises:
an ansatz parametric circuit implementing an ansatz, wherein the ansatz parametric circuit is configured to approximate a target quantum state of a second physical phenomenon, the ansatz parametric circuit is configured to manipulate the sensed quantum state of the one or more qubits, thereby outputting at least one manipulated quantum state; and
an assessing module configured to obtain the at least one manipulated quantum state from the ansatz parametric circuit, and to assess an expectation value of one or more operators on the at least one manipulated quantum state;
implement, at said quantum computer, a Variational Quantum Eigensolver (VQE) scheme to iteratively adjust one or more values of a set of parameters defining the ansatz parametric circuit until the assessing module provides a desired expectation value; and
output the desired expectation value.
